(19) United States
(12) Patent Application Publication
(10) Pub. No.: US 2024/0348670 A1
(43) Pub. Date: Oct. 17, 2024

(54) APPARATUS AND METHOD FOR REQUESTING TIME SENSITIVE COMMUNICATION MANAGEMENT INFORMATION IN WIRELESS COMMUNICATION SYSTEM

(71) Applicant: ELECTRONICS AND TELECOMMUNICATIONS RESEARCH INSTITUTE, Daejeon (KR)

(72) Inventors: Yoo Hwa Kang, Daejeon (KR); Namseok Ko, Daejeon (KR); Changki Kim, Daejeon (KR)

(21) Appl. No.: 18/628,438

(22) Filed: Apr. 5, 2024

(30) Foreign Application Priority Data
Apr. 7, 2023 (KR) 10-2023-0045933
Apr. 5, 2024 (KR) 10-2024-0046392

(51) Int. Cl. H04L 65/1096; H04L 65/1069; H04W 28/02

(52) U.S. Cl. CPC H04L 65/1096; H04L 65/1069; H04W 28/0215

(57) ABSTRACT

Proposed is an apparatus and method for requesting time-sensitive communication (TSC) management information, wherein the method for directly sending TSC management information in wireless communication systems may include a process of sending TSC management information from TSN AF (time-sensitive network application function) to PCF (policy control function), where TSC management information is composed of at least one of PMIC, a port number, and UMIC, and an address information of a target NF, a process of PCF sending the changed policy information to SMF when there is a change in policy information, where the changed policy information is composed of TSC management information, and a process of requesting TSC management information to be included when the SMF requests PFCP session report from UPF.

### CROSS REFERENCE TO RELATED APPLICATION

The present application claims priority to Korean Patent Application No. 10-2023-0045933, filed on Apr. 7, 2023, and 10-2024-0046392, filed on Apr. 5, 2024, the entire contents of which are incorporated herein for all purposes by this reference.

### BACKGROUND

### Technical Field

The present disclosure generally relates to a wireless communication system and, more particularly, to an apparatus and method for requesting time-sensitive communication management information.

### Description of the Related Art

Wireless communication technology is increasingly playing an important role in modern society. In other words, wireless communication is playing a key role in a variety of applications such as mobile communication, Internet access, smart systems, autonomous vehicles and the like. In this environment, the efficiency and reliability of wireless communication systems are becoming even more important.

Wireless communication systems need to process a large number of data and signals in real time, especially important data such as time-sensitive management information. The optimization and management of requesting and sending such information have a significant impact on improving the performance of communication systems and connection stability.

### SUMMARY

The present disclosure provides an apparatus and method for requesting time-sensitive communication management information in a wireless communication system on the basis of the above discussion.

In addition, the present disclosure provides an apparatus and method for providing a function of a packet forwarding control protocol (PFCP) in order to request that a user plane function (UPF) sends time-sensitive communication (TSC) management information as a UPF event exposure service in a wireless communication system.

In addition, the present disclosure provides an apparatus and method, wherein a session management function (SMF) via a policy control function (PCF) enables a UPF to directly send TSC management information as an event exposure notification to a network function (NF) when the network function (NF) requests TSC management information as an event in a wireless communication system.

In addition, the present disclosure provides an apparatus and methods, where a SMF requests through a N4 interface a UPF to provide TSC management information as an event exposure service in a wireless communication system.

According to various exemplary embodiments of the present disclosure, an operation method for directly sending time-sensitive communication (TSC) management information in a wireless communication system may include a process of sending TSC management information from a TSN AF (time-sensitive network application function) to a PCF (policy control function), wherein TSC management information is composed of at least one of a PMIC (port management information container), a port number, and a UMIC (user plane node management information container), and an address information of a target NF, a process of the PCF sending the changed policy information to a SMF (session management function) when there is a change in a policy information, wherein the changed policy information is composed of TSC management information, and a process of requesting TSC management information to be included when the SMF requests a PFCP (packet forwarding control protocol) session report from a UPF (user plane function).

According to various exemplary embodiments of the present disclosure, an apparatus for directly sending time-sensitive communication (TSC) management information in a wireless communication system may include a transceiver and a controller operably connected to the transceiver, wherein the controller enables TSC management information to be sent from a TSN AF (time-sensitive network application function) to a PCF (policy control function), wherein TSC management information is composed of at least one of a PMIC (port management information container), a port number, and a UMIC (user plane node management information container), and an address information of a target NF (network function), enables the PCF to send the changed policy information to a SMF (session management function) when there is a change in a policy information, wherein the changed policy information is composed of TSC management information, and enables the SMF to request TSC management information to be included when requesting a PFCP (packet forwarding control protocol) session report from a UPF (user plane function).

The apparatus and method according to various exemplary embodiments of the present disclosure enables the SMF (session management function) to request the UPF event notification rather than the TSN (application function) or the TSCTSF (time-sensitive communication and time synchronization function) request TSC management information in order to provide time-sensitive communication (TSC) management information as a UPF event exposure service in a 5GS (5G system), thereby minimizing an impact by maximally accommodating existing standards and selectively providing either traditional procedures or UPF exposure services depending on whether UPF's exposure services are available.

The effects obtained in the present disclosure are not limited to the effects mentioned above, and other effects not mentioned will be clearly understood by those skilled in the art to which the present disclosure belongs from the description below.

### BRIEF DESCRIPTION OF THE DRAWINGS

FIG. 1 is a view showing an example of an NF service provided by a UPF according to various exemplary embodiments of the present disclosure.

FIG. 2 is a view showing a flowchart of a signal for providing TSC management information as a UPF event exposure service according to various exemplary embodiments of the present disclosure.

FIG. 3 is a view showing an example of information in which an SMF requests TSC management information report from a UPF according to various exemplary embodiments of the present disclosure.

FIG. 4 is a view showing an example of a 5GS bridge information reporting procedure according to an exemplary embodiment of the present disclosure.

FIG. 5 is a view showing an example of information that requests to report TSC management information according to an exemplary embodiment of the present disclosure.

FIG. 6 is a view showing a procedure in which a PCF requests a SMF to update a policy information when there is a change in the policy information according to an exemplary embodiment of the present disclosure.

FIG. 7 is a view showing an example of TSC management information that a SMF sends to a UPF according to an exemplary embodiment of the present disclosure.

FIG. 8 is a view showing an example of TSC management information that a SMF sends to a UPF via a PFCP according to an exemplary embodiment of the present disclosure.

FIG. 9 is a view showing a configuration diagram of a NF in a wireless communication system according to various exemplary embodiments of the present disclosure.

FIG. 10 is a view showing an apparatus configuration according to various exemplary embodiments of the present disclosure.

### DETAILED DESCRIPTION OF THE DISCLOSURE

Terms used in the present disclosure are used only to describe specific exemplary embodiments and may not be intended to limit the scope of other exemplary embodiments. Singular expressions may include plural expressions unless the context clearly indicates otherwise. Terms used herein, including technical or scientific terms, may have the same meaning as those commonly understood by a person of ordinary skill in the technical field described in this disclosure. Terms defined in general dictionaries among the terms used in the present disclosure may be interpreted as the same or similar to the contextual meaning of the relevant technology and may not be interpreted as ideal or excessively formal unless explicitly defined in the present disclosure. In some cases, even terms defined in the present disclosure should not be construed to exclude exemplary embodiments of the present disclosure.

In various exemplary embodiments of the present disclosure described below, a hardware-based approach method may be explained as an example. However, various exemplary embodiments of the present disclosure may not exclude a software-based approach since various exemplary embodiments of the present disclosure include technology using both hardware and software.

In addition, “at least one A, B, and C” in the detailed description and claims of this disclosure may mean “only A”, “only B”, “only C”, or “any combination of A, B, and C”. In addition, “at least one A, B, or C” or “at least one A, B, and/or C” may mean “at least one A, B, and C”.

Hereinafter, the present disclosure relates to an apparatus and method for requesting time-sensitive communication management information in a wireless communication system. Specifically, t disclosure describes a technology that allows an SMF (session management function) to request a UPF event notification rather than a TSN (application function) a or TSCTSF (time-sensitive communication and time synchronization function) request TSC management information in order to provide time-sensitive communication (TSC) management information as a UPF event exposure service in a 5GS (5G system), thereby minimizing an impact by maximally accommodating existing standards and selectively providing either traditional procedures or UPF exposure services depending on whether UPF's exposure services are available.

In the following description, terms referring to signals, terms referring to channels, terms referring to control information, terms referring to network entities, terms referring to device components, and the like are exemplified for the convenience of explanation. Accordingly, the present disclosure is not limited to terms to be described below, and other terms having equivalent technical meaning may be used.

In addition, the present disclosure describes various exemplary embodiments using terms used in some communication standards (e.g., 3GPP (3rd Generation Partnership Project)), but these are only examples for explanation. Various exemplary embodiments of the present disclosure may be easily modified and applied to other communication systems.

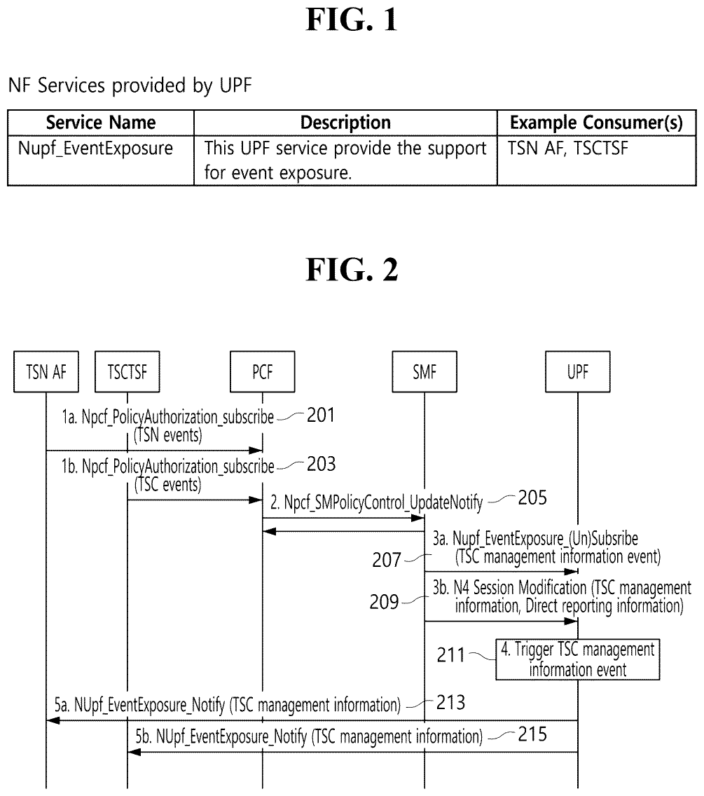

FIG. 1 is a view showing an example of an NF service provided by a UPF according to various exemplary embodiments of the present disclosure.

Referring to FIG. 1, the NF provided by a UPF may be a time-sensitive communication application function (TSC AF) and a time-sensitive communication and time synchronization function (TSCTSF) as examples.

In addition, referring to FIG. 1, an NF service for providing TSC management information as a UPF event exposure is Nupf_EventExposure as an example.

In a 5GS (5G system or NR system), the UPF (a user plane function) may send through an N4 interface various event information (e.g., QOS monitoring information, network data analytics function (NWDAF) analysis information, etc.) with both a SMF (session management function) and a N4 (point to point) interface.

In the 3GPP Rel-18, an exposure service is provided to directly send event information that the UPF sends through the SBI to the requesting NF (network function). For this, a solution to send TSC management information as a UPF event exposure is proposed in the 3GPP TR 23.700-62 (UPEAS: Study on UPF enhancement for Exposure and SBA) standard study.

FIG. 2 is a view showing a flowchart of signals for providing TSC management information as a UPF event exposure according to various exemplary embodiments of the present disclosure. Specifically, FIG. 2 shows a flowchart of signals for a UPF event exposure based on an SMF subscription.

Referring to FIG. 2, FIG. 2 defines a packet forwarding control protocol (PFCP) for an N4 interface between an SMF and a UPF on the basis of 3GPP TS 29.244.

Referring to FIG. 2, a TSF AF may request a subscription to a TSN event from a PCF 201. In addition, a TSCTSF may request a subscription to a TSC event from the PCF 203.

Operations 201 and 203 may be operations for a policy subscription.

The PCF may notify the SMF of a policy control update 205. That is, an operation 205 may be an operation for notifying a SMF policy control update.

The SMF may request the UPF to request or cancel a subscription to the TSC management information event via service based interface 207. In addition, the SMF may (un) subscribe the SMF of TSC management information including direct reporting information for session modification via N4 interface 209. Operations 207 and 209 may be operations related to the UPF event exposure and a session modification notification to (un) subscribe UPF events.

When an event occurs, the UPF may trigger TSC management information event by notifying the SMF of the event information (211). In addition, the UPF may inform the subscribed TSN AF or TSCTSF of TSC management information event (213). Operations 211 and 213 may be operations related to UPF event exposure notification.

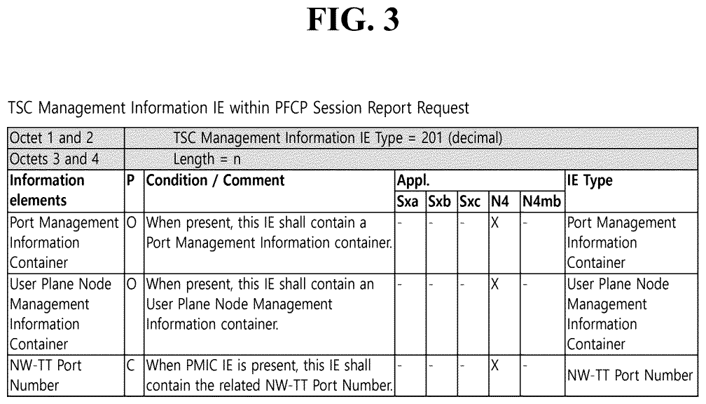

FIG. 3 is a view showing an example of information in which an SMF requests TSC management information report from a UPF according to various embodiments of the present disclosure.

Referring to FIG. 3, the information (TSC management information IE within PFCP Session Report Request), in which an SMF requests TSC management information report from a UPF, may include a PMIC (port management information container), a UMIC (user plane node management information container), and a NW-TT port number.

The PMIC may include a port management information and may include a management command or information for a specific port.

The UMIC may include a user plane node management information and may include information related to the management of the user plane node.

The NW-TT port number may include a relevant NW-TT port number when a PMI container exists.

Referring to FIG. 3, Octet 1 and Octet 2 may indicate the type of TSC Management Information IE. The type of TSC Management Information IE may be specified as 201 (decimal). In addition, Octet 3 and Octet 4 may indicate the length (n) of TSC Management Information IE.

Referring to FIG. 3, Applicability (Appl.) may list interfaces to which each information element is applied, and applicability may include Sxa, Sxb, Sxc, N4, and N4mb. In addition, IE type may indicate the type of each IE.

When the NF (e.g., TSN AF (time-sensitive networking application function), TSCTSF (time-sensitive communication time synchronization function)) requests TSC management information as an event, the SMF via the PCF (policy control function) should be able to request a UPF to directly send TSC management information as an event exposure notification to the NF according to 3GPP TR 23.700-62 (Rel-18). Since there is no information for an event exposure notification in a PFCP information in which the SMF currently requests TSC management information report from the UPF, the present disclosure proposes a method for the SMF to request the UPF through the N4 interface in order for the UPF to provide TSC management information as an event exposure service.

Therefore, the present disclosure proposes an apparatus and method, wherein the SMF via a PFCP requests TSC management information from the UPF so that the UPF provides TSC management information as an event exposure service. For this, when the NF (TSN AF or TSCTSF) requests a TSC management information event, a new PFCP parameter may be additionally defined and sent through the N4 interface so that the SMF via the PCF requests a TSC management information event from the UPF.

In order to provide TSC management information as the UPF exposure service, the present disclosure proposes a method in which the SMF requests the corresponding service. According to 3GPP standards, TSC management information that the TSN AF sends to the PCF and finally to the UPF may include at least one of a PMIC (port management information container), a port number, and a UMIC (user plane node management information container).

A TSC management information event for the UPF event exposure service may be defined in the 5G system. Nupf_EventExposure service operations that are provided in the 5G system in order for the UPF to send the corresponding event are as follows.
Nupf_EventExposure_Subscribe.
Nupf_EventExposure_UnSubscribe.
Nupf_EventExposure_Notify.

The present disclosure allows the SMF to request UPF event notifications by maximally accommodating the standard procedures where TSC management information sent by TSNAF/TSCTSF is sent through SMF via the existing PCF rather than TSNAF and TSCTSF directly performs Nupf_EventExposure_Subscribe.

In this case, the way the SMF requests may be to extend and use the PFCP used for the existing N4 interface without using the Nupf_EventExpose_Subscription. The requested TSC management information event notification may be directly sent to the TSN AF or TSCTSF by the UPF using the Nupf_EventExpose_Notify. In this case, the UPF event notification may include at least one of TSC management information (a PMIC, a UMIC, or NW-TT port number).

When the TSN AF/TSCTSF subscribes to the TSC management information event of the UPF and any change in the PMIC and UMIC contents occurs in the UPF, the UPF may send an event notification to the subscribed TSN AF/TSCTSF. Accordingly, the TSN AF/TSCTSF may receive the changed TSC management information through the event notification.

In the present disclosure, a target NF address to which an event is reported may be additionally requested so that the UPF sends TSC management information as a UPF event notification. Specifically, the following information may be additionally requested.
Notification Target Address+Notification Correlation ID (TSN AF or TSCTSF)

For this, first the target of the reporting (Notification Target Address+Notification Correlation ID) parameter may be added to the information that the TSNAF or TSCTSF sends to the PCF.

When the TSNAF/TSCTSF is to be notified of events while sending TSC management information to the PCF, the TSNAF/TSCTSF may additionally send the target of the reporting parameter by adding itself as the target address. The TSNAF/TSCTSF, which is the target address sent in this way, may directly receive the TSC management information event notification from the PCF or the UPF.

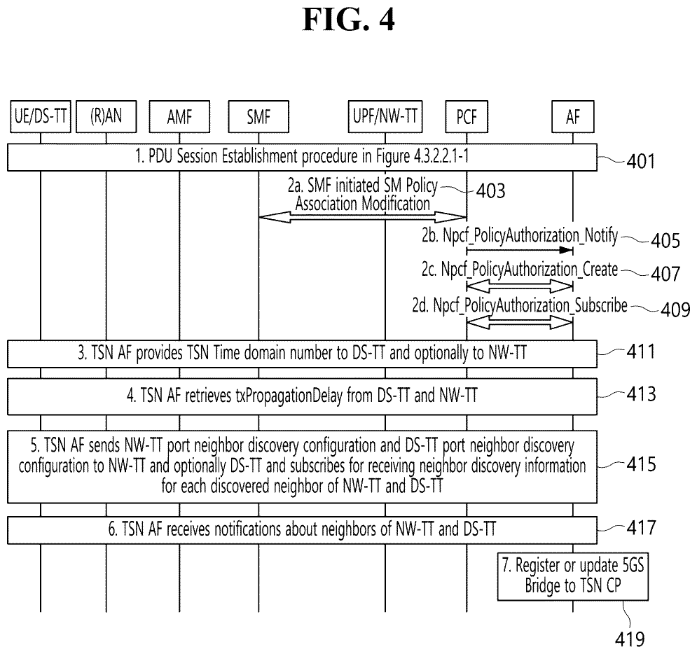

FIG. 4 is a view showing an example of a 5GS bridge information reporting procedure according to an exemplary embodiment of the present disclosure. Specifically, FIG. 4 shows a 5GS bridge information reporting procedure defined in 3GPP TS 23.502 which includes a step of reporting 5GS TSC management information to the TSNAF/TSCTSF.

Referring to FIG. 4, the TSNAF/TSCTSF may send TSC management information to the PCF in the operation 405 and in the operation 407, and may request a bridge information notification through the operation 409.

Referring to FIG. 4, a protocol data unit (PDU) session establishment procedure may be initiated between a UE and an AMF (401).

The SMF may exchange messages with the PCF in order to modify a previously established SM policy association (the operation 403 to the operation 409). Specifically, the SMF may exchange a policy authorization request or notification with the PCF (403). The SMF may send a request to create a policy authorization to the PCF (405). The SMF may exchange a subscription request for a specific event with the PCF (407). The SMF may exchange reports on a user plane with the PCF (409).

The TSN AF may provide a TSN time domain number to a DS-TT (411). The TSN AF may provide the TSN time domain number to an NW-TT in some cases according to an exemplary embodiment.

The TSN AF may retrieve a propagation delay from the DS-TT and the NW-TT (413).

The TSN AF may send a neighbor discovery configuration with respect to the NW-TT and the DS-TT and then may subscribe to receiving neighbor discovery information for each discovered neighbor (415).

The TSN AF may receive a notification about neighbors of the NW-TT and the DS-TT (417).

The TSN AF (or AF) may register or update the 5GS bridge information to a TSN CP. This may include information necessary for a network to direct traffic of a UE to an appropriate path.

In this disclosure, the TSNAF/TSCTSF may add the previously proposed target of the reporting (Notification Target Address+Notification Correlation ID) parameter to the Npcf_PolicyAuthorization_Create (target of reporting) for use when sending a message to the PCF in the operation 407. In addition, it may also be proposed to add to the Npcf_PolicyAuthorization_Update (target of Reporting) message.

In addition, the Npcf_PolicyAuthorization Subscribe (target of Reporting) message in use may be used in the existing manner in the operation 409 according to an exemplary embodiment in the present disclosure.

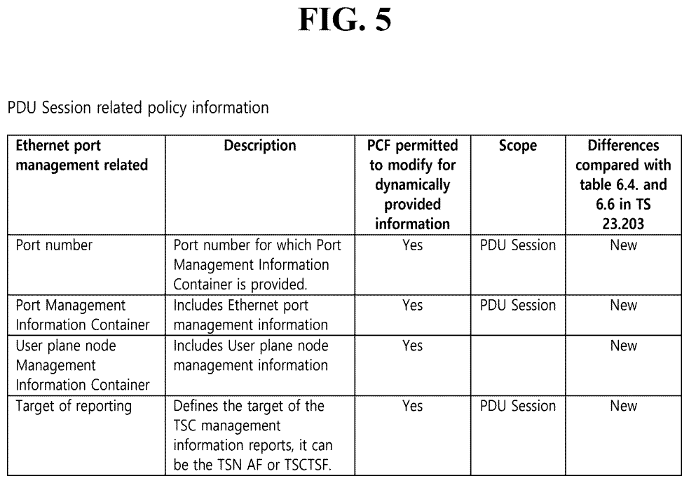

FIG. 5 is a view showing an example of information that requests to report TSC management information according to an exemplary embodiment of the present disclosure. Specifically, FIG. 5 shows adding the target of a reporting information received from the TSNAF/TSCTSF to a PDU session-related policy information in order for the PCF to send to the SMF in 3GPP TS 23.503.

Referring to FIG. 5, it may be seen that the target of the reporting information is added to PDU session-related policy information in the last row of FIG. 5 so that the PCF reports TSC management information to the SMF.

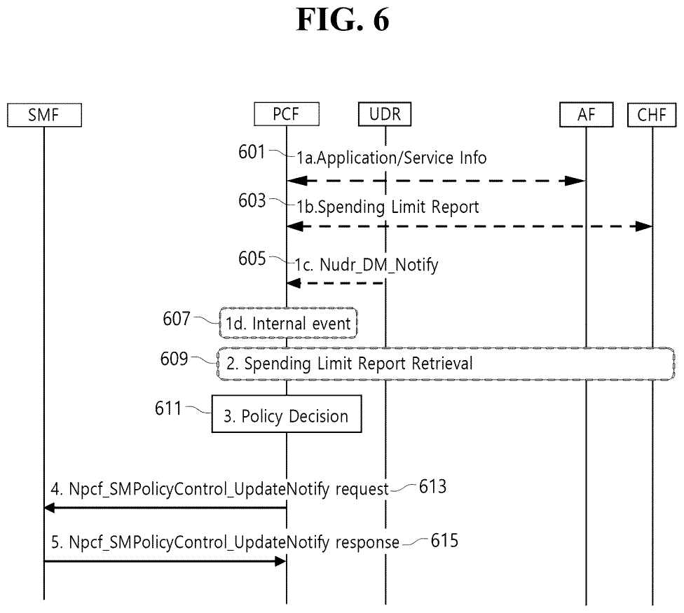

FIG. 6 is a view showing a procedure in which the PCF requests a policy information modification from the SMF when there is a change in a policy information according to an exemplary embodiment of the present disclosure. In detail, FIG. 6 shows a case where a TSN AF sends TSC management information to the UPF.

Referring to FIG. 6, the TSN AF may send TSC management information to the PCF (601).

The TSN AF may send a spending limit report to a CHF (603).

The UDR may update data or give a notification by sending a notification to the PCF (605).

The PCF may identify an event occurring inside the PCF (607).

The PCF may retrieve a spending limit report (609).

The PCF may make policy decisions based on the retrieved information (611). According to an exemplary embodiment, the retrieved information may include the spending limit report.

In the operation 613, the PCF may send the changed policy information to the SMF using the Npcf_SMPpolicyControl_UpdateNotify service operation (613). The changed TSC management information may also be sent using the Npcf_SMPpolicyControl_UpdateNotify service operation. In addition, the PDU session-related policy information defined in FIG. 5 may be sent as an input parameter.

The SMF may send a response to an update notification to the PCF (615). That is, the operation 615 may be a response message corresponding to the operation 613.

Therefore, the PCF may send to the SMF the target of the reporting parameter added for a UPF event notification in FIG. 5.

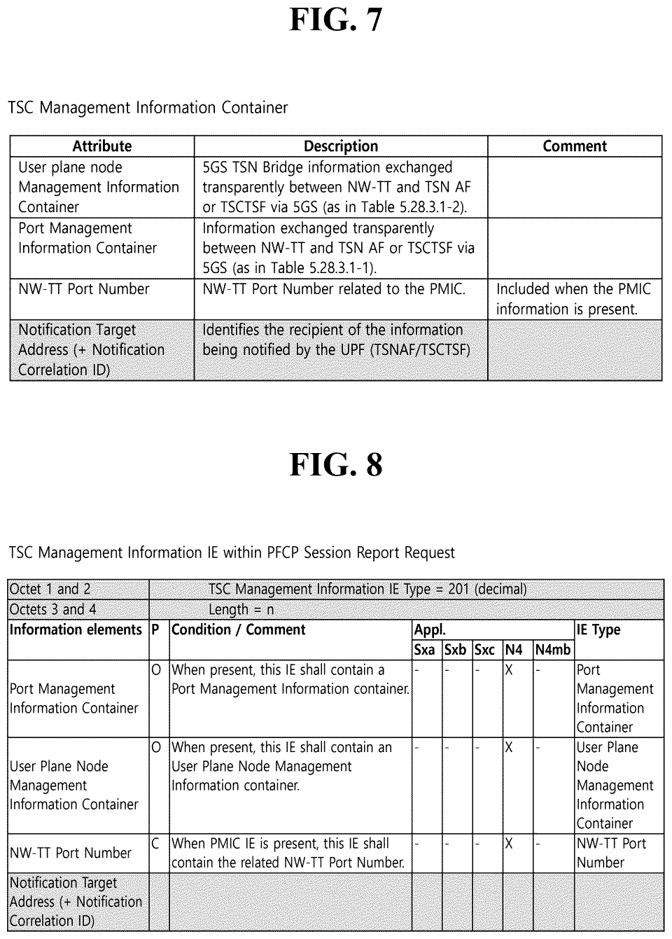

FIG. 7 is a view showing an example of TSC management information that an SMF sends to a UPF according to an exemplary embodiment of the present disclosure. Specifically, FIG. 7 shows TSC management information where an additional notification target address is defined for an UPF event notification and is added to TSC management information.

The notification target address (shaded) may indicate an event notification request, and the UPF receiving it may directly send the UPF event notification to the NF (TSN AF or TSCTSF) that requests the event when providing an exposure service. When not providing the exposure service, the UPF may send the TSC management information event to the TSNAF/TSCTSF via the PCF as in the existing standard by sending TSC management information to the SMF as in the existing manner.

FIG. 8 is a view showing an example of TSC management information that an SMF sends to a UPF through a PFCP according to an exemplary embodiment of the present disclosure. Specifically, FIG. 8 shows TSC management information that an SMF sends to a UPF through a PFCP by adding a notification target address (+Notification Correlation ID) to a parameter that requests a TSC management information report in a unit of PFCP session defined in the 3GPP TS 29.244 standard.

Referring to FIG. 8, the SMF may include TSC management information defined in FIG. 8 when requesting a PFCP Session Report Request to the UPF, and may add and send a newly defined notification target address when requesting a UPF event notification.

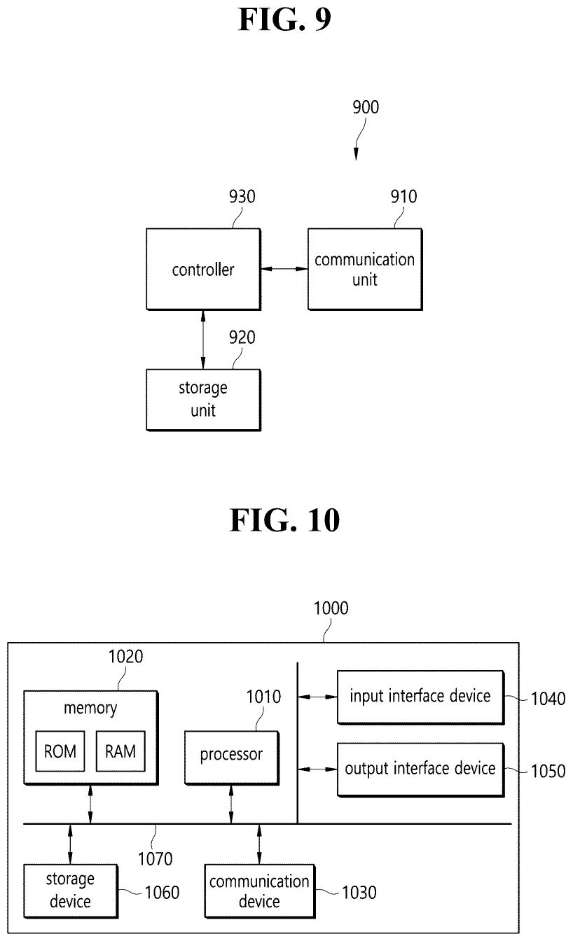

FIG. 9 is a view showing a configuration diagram of an NF in a wireless communication system according to various exemplary embodiments of the present disclosure. The configuration exemplified in FIG. 9 may be understood as a configuration of a network function (NF) 900. Hereinafter, terms such as “ . . . unit” and “ . . . part” refer to a unit for processing at least one function or operation, which may be implemented by hardware or software, or a combination of hardware and software. In the NF of FIG. 9, SMF, PCF, UDR, AF, CHF, UE, (R) AN, AMF, NW-TT, PCF, TSC AF, and TSCTSF are exemplified, but are not limited thereto.

Referring to FIG. 9, the NF 900 may include a communication unit 910, a storage unit 920, and a controller 930.

The communication unit 910 may perform functions for sending and receiving a signal. The communication unit 910 may send and receive a signal as described above. Accordingly, all or part of the communication unit 910 may be referred to as a “transmitter”, “receiver”, or “transceiver”. In addition, sending and receiving performed over a wireless channel as described herein may be used to mean that such processing as described above is performed by the communication unit 910.

A storage unit 920 may store data such as basic programs, applications, and setting information for NF operations. The storage unit 920 may be composed of a volatile memory, a non-volatile memory, or a combination of the volatile memory and the non-volatile memory. Furthermore, the storage unit 920 may provide data stored according to the request of the controller 930.

The controller 930 may control the overall operations of the NF. For example, the controller 930 may send and receive signals through the communication unit 910. In addition, the controller 930 may record and read data in the storage unit 920. The controller 930 may perform functions of a protocol stack required by a communication standard. For this, the controller 930 may include at least one processor or micro-processor, or may be a part of a processor. In addition, a part of the communication unit 910 and the controller 930 may be referred to as a communication processor (CP).

FIG. 10 is a diagram showing a configuration of an apparatus according to various exemplary embodiments of the present disclosure.

Referring to FIG. 10, an apparatus 1000 for directly sending time-sensitive communication (TSC) management information may include at least one processor 1010, a memory 1020, and a communication device 1030 that is connected to and communicates with a network. In addition, the apparatus 1000 may further include an input interface device 1040, an output interface device 1050, a storage device 1060, and the like. Each of the components included in the apparatus 1000 may be connected by a bus 1070 to communicate with each other.

However, each component included in the apparatus 1000 may be connected through an individual interface or an individual bus centering on the processor 1010 instead of the common bus 1070. For example, the processor 1010 may be connected to at least one of the memory 1020, the communication device 1030, the input interface device 1040, the output interface device 1050, and the storage device 1060 through a dedicated interface.

The processor 1010 may execute a program command stored in at least one of the memory 1020 and the storage device 1060. The processor 1010 may refer to a central processing unit (CPU), a graphics processing unit (GPU), or a dedicated processor for performing methods according to exemplary embodiments of the present disclosure. Each of the memory 1020 and the storage device 1060 may be configured with at least one of a volatile storage medium and a non-volatile storage medium. For example, the memory 1020 may be configured with at least one of a read-only memory (ROM) and a random access memory (RAM).

In this disclosure, when the SMF requests an event notification through a UPF exposer service by adding the notification target address parameter in case of requesting a PFCP session report, the UPF receiving the request may be proposed to operate as follows.

When providing an exposure service, the UPF may directly send the TSC management information event information in a Nupf_EventExposure_Notify (TSC Management Information) message with the notification target address as the target.

When not providing an exposure service, the UPF may report TSC management information to the SMF through the PFCP as in the existing procedure. Upon receiving the TSC management information notification, the SMF may send the event notification to the TSNAF/TSCTSF through the PCF.

According to various exemplary embodiments of the present disclosure, the present disclosure may allow the SMF to request a UPF event exposure service through the PFCP so that UPF may directly send TSC management information to the NF (TSN AF or TSCTSF) in the 5G system (5GS, 5G System).

According to an exemplary embodiment, a target NF address (Notification Target Address (+Notification Correlation ID)) that reports an event may be added for a UPF event notification request.

According to an exemplary embodiment, TSNAF/TSCTSF may add a notification target address (+Notification Correlation ID) to the input parameter of the Npcf_PolicyAuthorization_Create and Npcf_PolicyAuthorization_Update service operations in case of requesting a UPF event notification when sending TSC management information to the PCF.

According to an exemplary embodiment, the SMF may add the notification target address (+Notification Correlation ID) defined when requesting a PFCP session report to TSC management information that the SMF sends to the UPF in order to request an UPF event notification.

Methods according to exemplary embodiments described in the claims or specification of the present disclosure may be implemented in the form of hardware, software, or a combination of hardware and software.

When implemented as software, a computer-readable storage medium that stores one or more programs (software modules) may be provided. One or more programs stored in a computer-readable storage medium may be configured to be executable by one or more processors in an electronic device. One or more programs may include instructions that lead the electronic device to execute methods according to exemplary embodiments described in the claims or specification of the present disclosure.

Such programs (software modules, software) may be stored in a random access memory, a non-volatile memory including a flash memory, a read-only memory (ROM), an electrically erasable programmable read-only memory (EEPROM), a magnetic disk storage device, a compact disc-ROM, a digital versatile disc (DVDs), or another type of optical storage device, and a magnetic cassette. Alternatively, the programs may be stored in a memory composed of a combination of some or all thereof. In addition, each component memory may be included in multiple.

In addition, the program may be stored in an attachable storage device that is accessible through a communication network such as the Internet, an intranet, a local area network (LAN), a wide area network (WAN), or a storage area network (SAN), or any combination thereof. Such a storage device may access an apparatus performing an exemplary embodiment of the present disclosure through an external port. Also, a separate storage device on a communication network may access an apparatus performing an exemplary embodiment of the present disclosure.

In the specific exemplary embodiments of the present disclosure described above, components included in the disclosure may be expressed in singular or plural numbers depending on the specific exemplary embodiment presented. Although singular or plural expressions may be selected to suit a situation presented for the convenience of explanation, the present disclosure may be not limited to singular or plural components, such that components expressed in the plural may be comprised in the singular, or components expressed in the singular may be comprised in the plural.

Meanwhile, specific exemplary embodiments have been described in the detailed description of the present disclosure, but various modifications are possible without departing from the scope of the present disclosure. Therefore, the scope of the present disclosure should not be limited to the described exemplary embodiments and should be determined not only by the scope of the patent claim described later but also by equivalents to the scope of this patent claim.

What is claimed is:

1. An operation method for directly sending a time-sensitive communication (TSC) management information in a wireless communication system, the method comprising:
sending the TSC management information from a TSN AF (time-sensitive network application function) to a PCF (policy control function), wherein the TSC management information comprises at least one of a PMIC (port management information container), a port number, and a UMIC (user plane node management information container), and an address information of a target NF (network function);
sending by the PCF a changed policy information to a SMF (session management function) when there is a change in a policy information, wherein the changed policy information comprises the TSC management information; and
requesting the TSC management information to be included when the SMF requests a PFCP (packet forwarding control protocol) session report from a UPF (user plane function).

2. The method of claim 1, wherein the address information of the target NF is added to Npcf_PolicyAuthorization_Create and is sent to the PCF.

3. The method of claim 1, wherein the address information of the target NF is added to Npcf_PolicyAuthorization_Update and is sent to the PCF.

4. The method of claim 1, further comprising a process of directly sending the TSC management information to the target NF on the basis of the address information of the target NF that is included in the TSC management information when the UPF provides an exposure service.

5. The method of claim 1, further comprising a process of sending the TSC management information to the SMF through the PFCP (packet forwarding control protocol) when the UPF does not provide an exposure service.

6. The method of claim 5, wherein the SMF comprises process of receiving the TSC management information and a process of sending an event notification to the target NF through the PCF.

7. The method of claim 4, wherein the address information of the target NF comprises a notification correlation ID.

8. An apparatus for directly sending a time-sensitive communication (TSC) management information in a wireless communication system, the apparatus comprising:
a transceiver; and
a controller operably connected to the transceiver, wherein the controller
enables the TSC management information to be sent from a TSN AF (time-sensitive network application function) to a PCF (policy control wherein function), the TSC management information comprises at least one of a PMIC (port management information container), a port number, and a UMIC (user plane node management information container), and an address information of a target NF (network function),
enables the PCF to send the changed policy information to a SMF (session management function) when there is a change in a policy information, where the changed policy information comprises the TSC management information, and
enables the SMP to request the TSC management information to be included when requesting a PFCP (packet forwarding control protocol) session report from a UPF (user plane function).

9. The apparatus of claim 8, wherein the address information of the target NF is added to Npcf_PolicyAuthorization_Create and is sent to the PCF.

10. The apparatus of claim 8, wherein the address information of the target NE is added to Npcf_PolicyAuthorization_Update and is sent to the PCF.

11. The apparatus of claim 8, wherein the controller directly sends the TSC management information to the target NF on the basis of the address information of the target NF that is included in the TSC management information when the UPF provides an exposure service.

12. The apparatus of claim 8, wherein the controller sends the TSC management information to the SMF through the PFCP (packet forwarding control protocol) when the UPF does not provide an exposure service.

13. The apparatus of claim 12, wherein the controller enables the SMF to receive the TSC management information and send an event notification to the target NF through the PCF.

14. The apparatus of claim 11, wherein the address information of the target NF comprises a notification correlation ID.
